(19) United States
(12) Patent Application Publication
(10) Pub. No.: US 2014/0271030 A1
(43) Pub. Date: Sep. 18, 2014

(54) FASTENING MATERIAL

(71) Applicant: CANON KABUSHIKI KAISHA, Tokyo (JP)

(72) Inventor: Yoshimasu Yamaguchi, Kawasaki-shi (JP)

(73) Assignee: CANON KABUSHIKI KAISHA, Tokyo (JP)

(21) Appl. No.: 14/202,460

(22) Filed: Mar. 10, 2014

(30) Foreign Application Priority Data
Mar. 14, 2013 (JP) 2013-052547

(51) Int. Cl. F16B 43/00

(52) U.S. Cl. CPC F16B 43/00
USPC 411/313

(57) ABSTRACT

A fastening material for fastening a fastening object material between itself and a screw, said fastening material includes a burred portion forming a screw hole and projecting in a substantially cylindrical shape in a screw inserting direction, wherein said burred portion has a wave-like shape portion waving in a circumferential direction of the cylindrical shape.

### FIELD OF THE INVENTION AND RELATED ART

The present invention relates to a fastening material or member and a screw hole burring method. More particularly, the fastening portion structure and the screw hole burring method for a thin metal plate material, for burring around the screw hole to reinforce the screw fastening structure.

In a known structure, a plate member (fastening material) of metal and a fastening object material of metal or resin material are fixed by a screw (thread). The fixing using a screw is widely used in manufacturing devices or exchanging of parts, because the fixing and removing is easy. In the case of the fastening material and the fastening object material having quite large thicknesses, the fastening material and the fastening object material are fixed with each other by engaging the screw with the screw hole provided in the fastening object material.

Also in the case of thin fastening material (metal plate) having a small thickness such as about 1 mm, it is necessary to assuredly fix the fastening object material to the fastening material by a screw for a thin plate. To accomplish this, the screw hole portion of the fastening material to be engaged with the screw is subjected to a burring process to assure the screw hole depth (burring height). A method is known to increasing a thickness of the screw engaging portion by a burring process as compared with the case of simple screw boring processing the fastening material.

Japanese Laid-open U.M. Application Hei 6-66821 proposes a burring processing structure for a prepared hole for tapping in which an inner surface adjacent a free end portion of the prepared hole where the screw is formed is expanded by plastic deformation to provide a thickened portion which has an inner diameter smaller than the prepared hole.

By such a structure, a effective thread ridge engaging ratio is made 100% to enhance a confining torque, thus increasing the strength of the fastening portion as compared with the prior art structure.

Using the burring process, the number of the processing steps increases, and therefore, Japanese Laid-open Patent Application Hei 09-164431 proposes the following method in order to reduce the processing step number and the processing cost in the burring process for the fastening material and enhancing the processing efficiency.

It is a burring step without a preliminary drawing step including a burring except for small diameter pierce-burring such as prepared hole through one step. That is, Japanese Laid-open Patent Application Hei 09-164431 discloses such a burring forming process.

Japanese Laid-open Patent Application 2009-214151 discloses a structure in which an emboss portion forming and a piercing process are effected through a single step, and a so-called work confining mechanism such as a pad and a stripper are omitted. By cooperation of a lower mold including a button die having a die hole and an upper mold including a piercing punch, the formation of the emboss portion of the panel and the pierced hole formation for the emboss portion are effected by a single step. The pierced hole is first formed using a shear action cause by the piercing punch and the die hole at the time of lowering operation of the upper mold, and then the emboss portion is formed by pressing and confining the circumference of the pierced hole by the emboss forming surfaces of the upper and lower molds.

Referring back to Japanese Laid-Open Utility Model Application Hei 6-66821, an inner surface adjacent the free end portion of the prepared hole is expanded inwardly to provide a thickened portion, by the burring process. The inner diameter of the burring is equal to that of the prepared hole, and the fastening object material can be fastened by a metric coarse screw or a self-tapping screw.

The object of the burring process is to provide a screw crest contact portion as much as possible to assure the screw fastening force. To accomplish this, it is required to increase the burring height, and for this purpose, a thickness measure between the inside circumference and the outer position of the burring has to be decreased, but the thickness must not be fractured by the engagement of the ridge of the screw thread.

However, with the decrease of the plate thickness of the fastening material, the thickness between the inside circumference and the outer configuration portion of the burring becomes insufficient, with the result of fracture of the thin portion by the screw ridge, and therefore, the sufficient fastening force is unlikely assured. In addition, the burring process result is formation of round portion (flank) at the root of drawn portion. For this reason, when a step screw is used, no sufficient seat surface against the step portion is assured. Therefore, with the increase of the number of steps, the size of the entire screw portion increases, with the result of the bulkiness of the device.

The process of Japanese Laid-open Patent Application Hei 09-164431, is advantageous in the one step is enough for the burring process, the bent circumference portion of the burring is rounded, and therefore, similarly to Japanese Laid-Open Utility Model Application Hei 6-66821, the problem with the step screw arises again. Between the burring height and the scrap material removed by the burring, there is a relation that with the increase of the burring height, the amount of the scrap decreases. However, using the above-described processing, the attempt to increase the burring height may result in cracking in the burred portion.

It is not possible to increase the bur thickness without production of the scrap material, and therefore, there is a limit in use with a thin plate.

In addition, in Japanese Laid-open Patent Application 2009-214151, the formation of the embossed portion and the piercing process can be effected through a single step advantageously, and the tapping process can be carried out into the pierced hole, and the emboss portion is effective for reinforcement. However, from the standpoint of screw fastening for a thin plate, when a shearing force is applied to the screw portion after fastening, the fastening screw may easily tilt due to deformation of the thin plate.

In addition, since the screw engagement amount is small, the strength is not sufficient so that the necessary fastening torque can be provided.

In addition, looking in a direction facing the surface, the embossed portion is circular, and at the stepped portion of the emboss edge, the cross-sectional configuration of crank-like, and therefore, the bending strength is high. However, this does not reinforce the central pierced hole portion.

An example of the screw fastening to a thin plate provided with burred through a conventional burring process. FIGS. 1 and 2 show a fastening portion structure 90 of a screw fastening to a conventional burring shape provided in a thin metal plate, and experiment results. Parts (a), (b) and (c) of FIG. 1 are sectional views illustrating a conventional screw fastening state, and show a deformative fracture of the fastening portion. The fastening portion structure 90 shown in parts (a)-(c) of FIG. 1 will be described.

A screw 3 includes a screw head and a screw leg 32 (screw portion). The top of the screw head is provided with a cross-hole configuration (unshown) by which the screw 3 is rotated by a cross-slot screwdriver or the like. The outer peripheral surface of the screw leg 32 is provided with a male screw 32a. The screw head 31 is provided with a screw flange portion 34 at a screw leg (32) side having a large diameter. The screw flange portion 34 contacts the fastening object material 2 at a flange contact portion 2a.

The fastening material 1 which is a metal plate such as a thin steel plate is provided with a drawn burred portion 1′ having a burring height (h) by a burring process.

When a commercially available screw 3 having a flat flange for enhancing the fastening torque (RS tight tradename, available from Nitto Seiko Kabushiki Kaisha, Japan, for example) as shown in FIG. 1 is used, the fastening force is imparted outwardly, and the fastening material 1 which is a thin metal plate is deformed by the screw fastening force. At this time, the fastening material 1 deforms as indicated by an arrow A in parts (a), (b) and (c) of FIG. 1. With such a fastening portion structure 90, the prevention of the deformation of the fastening material 1 and the fastening object material 2, and the stability of the fastening force upon the re-fastening are not satisfactory.

### SUMMARY OF THE INVENTION

Accordingly, it is a principal object of the present invention to provide a fastening portion structure and screw hole burring method in which the rupture of the screw hole can be suppressed.

According to an aspect of the present invention, there is provided a fastening material for fastening a fastening object material between itself and a screw, said fastening material comprising a burred portion forming a screw hole and projecting in a substantially cylindrical shape in a screw inserting direction, wherein said burred portion has a wave-like shape portion waving in a circumferential direction of the cylindrical shape.

Further features of the present invention will become apparent from the following description of exemplary embodiments with reference to the attached drawings.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a sectional view showing a jack-up state of the fastening material when fastened, in a conventional screw fastening portion structure, in which part (a) shows deformation of the fastening object material and the lower surface of the fastening material by the jack-up by a screw fastening force, part (b) illustrates the deformation of the upper surface of the fastening material, and part (c) illustrates the deformation of the lower surface of the fastening material.

FIG. 2 illustrates a screw fastening portion structure according to an embodiment of the present invention, in which part (a) is a schematic side view of the screw fastening portion structure, part (b) is a schematic top plan view as seen from a screw head of the screw fastening portion structure, and part (c) is a schematic sectional view of the screw fastening portion structure.

FIG. 3 illustrates the screw fastening portion structure of the embodiment of the present invention. In FIG. 3, part (a) is a perspective view of a front side as seen from the screw head of the screw fastening portion structure, part (b) is a perspective view of a back side as seen from a screw shank of the screw fastening portion structure.

FIG. 4 illustrates a burred fastening material according to Embodiment 1. In FIG. 4, part (a) is a schematic side view, part (b) is a top plan view of a front side of the fastening material as seen a side opposite the burring, and part (c) is a schematic sectional view.

FIG. 5 illustrates a burred fastening material according to Embodiment 1. In FIG. 5, part (a) is a perspective view of a front side of the fastening material, and part (b) is a perspective view of the back side.

FIG. 6 illustrates pressing working steps for the burring process for the fastening material of the fastening portion structure. In FIG. 6, part (a) is a perspective view of a front side, part (b) is a perspective view of the back side, and parts (c)-(e) are schematic sectional views of the examples of the wave shape burring.

FIG. 7 illustrates pressing working steps for the burring process for the fastening material of the fastening portion structure. In FIG. 7, part (a) is a schematic side view, part (b) is a schematic top plan view of a front side, and part (c) is a schematic sectional view.

FIG. 8 illustrates a fastening portion structure according to Embodiment 2 of the present invention. In FIG. 8, part (a) is a schematic side view, part (b) is a top plan view of a front side, and part (c) is a schematic sectional view.

FIG. 9 illustrates a fastening portion structure according to Embodiment 2 of the present invention. In FIG. 9, part (a) is a perspective view of a front side, part (b) is a perspective view of the back side, and cone.

FIG. 10 illustrates a fastened state of the fastening portion structure according to Embodiment 2. In FIG. 10, part (a) is a perspective view of a front side, part (b) is a perspective view of the back side.

FIG. 11 illustrates a fastened state of the fastening portion structure according to Embodiment 2. In FIG. 11, part (a) is a schematic side view, part (b) is a top plan view of a front side, and part (c) is a schematic sectional view.

FIG. 12 illustrates pressing working steps for a burred portion according to Embodiment 2. In FIG. 12, part (a) is a schematic side view, part (b) is a top plan view of a front side, and part (c) is a schematic sectional view.

FIG. 13 illustrates pressing working steps for a burred portion according to Embodiment 2. In FIG. 13, (a) is a perspective view of a front side, and part (b) is a perspective view of a back side.

FIG. 14 illustrates a burred portion of a fastening portion structure according to an Embodiment 3 of the present invention. In FIG. 14, part (a) is a schematic side view, part (b) is a schematic top plan view of a front side, and part (c) is a schematic sectional view.

FIG. 15 illustrates a burred portion of the fastening portion structure of Embodiment 3, wherein part (a) is a perspective view of a front side, and part (b) is a perspective view of a back side.

FIG. 16 illustrates a pressing working step for the burred portion of the fastening portion structure of Embodiment 3. In FIG. 16, part (a) is a schematic side view, part (b) is a top plan view of a front side, and part (c) is a schematic sectional view.

FIG. 17 illustrates a pressing working step for the burred portion of the fastening portion structure of Embodiment 3. In FIG. 17, part (a) is a perspective view of a front side, part (b) is a perspective view of the back side, and cone.

FIG. 18 illustrates a fastening portion structure according to Embodiment 2 of the present invention. In FIG. 18, part (a) is a schematic side view, part (b) is a schematic top plan view of a front side, and part (c) is a schematic sectional view.

FIG. 19 illustrates a pressing working step for the burred portion of the fastening portion structure of Embodiment 3. In FIG. 19, (a) is a perspective view of a front side, and part (b) is a perspective view of a back side.

FIG. 20 illustrates a fastening material of a fastening portion structure according to Embodiment 4. In FIG. 20, part (a) is a schematic side view, part (b) is a schematic top plan view of a front side, and part (c) is a schematic sectional view.

FIG. 21 illustrates a fastening material of a fastening portion structure according to Embodiment 4. In FIG. 21, part (a) is a perspective view of a front side, part (b) is a perspective view of the back side, and cone.

### DESCRIPTION OF THE EMBODIMENTS:

### Embodiment 1

Parts (a), (b) and (c) of FIG. 2 and parts (a) and (b) of FIG. 3 illustrate a fastening portion structure having a burring according to an embodiment of the present invention.

As shown in the Figures, in a fastening portion structure 90 of this embodiment, a screw 3 is threaded into the fastening material 1, sandwiching the fastening object material 2, thus fastening the fastening object material 2 with the fastening material 1.

The screw 3 includes a screw head 31 and a screw shank 32. In this embodiment, a screw flange portion 34 having a large diameter is integrally provided on the screw head 31 at a screw shank 32 side. The screw flange portion 34 is a part of the screw head 31 and provides a seat portion 31a of the screw head 31.

As shown in part (b) of FIG. 2, a head apex portion 33 is provided with a cross-hole configuration 33a at which a cross-slot screwdriver or the like can rotate the screw 3.

As shown in part (c) of FIG. 2, an outer peripheral surface of the screw shank 32 has a male screw 32a (screw thread). The screw flange portion 34 constituting the seat portion 31a of the screw head 31 is at the screw shank 32 side of the screw head 31 and has a diameter, measured in a direction perpendicular to a longitudinal direction of the screw shank 32, larger than that of the screw head 31.

The fastening object material 2 is a thin metal plate of steel or the like and is provided with a screw hole 21. The fastening material 1 is a thin metal plate of steel or the like, with which an upper surface thereof is called a front side Ba, and the opposite side is called a back side Bb. The fastening material 1 is provided with a wave shape (corrugated) burring 11 provided by drawing a part of the fastening material 1 from the front side Ba to the back side Bb into a burring height h by a burring process.

In this specific example, the fastening material 1 is a thin electrolytic zinc-coated steel plate (JIS SECC-SD) provided by plating of an ordinary rolled steel plate (cold-rolled steel plate (JIS SPCC)). Or, it may be a so-called high-tension material (JIS G3134, JIS3135 SPFH, SPFC, or CA steel available from HTSS JFE, Japan). The plate thickness thereof is 0.4 mm, and it is not less than 0.3 mm and less than 0.8 mm approximately, when a M3 screw (metric coarse screw) is used.

A versatile steel plate ordinarily available in the market can be selected with increment of 0.1 mm (SPCC), and in the case of electrolytic zinc-coated steel plate, a next thickness above 0.6 mm is 0.8 mm. The present invention is applicable to high formability stainless steel, brass, aluminum or the like.

In the case of 0.8 mm of the plate thickness (t), it is possible to form the female screw by M3 tapping process (JIS/ISO metric coarse screw) using an ordinary burring process. Therefore, with the M3 screw, the practical range is 0.3 mm-0.6 mm of the plate thickness (t).

However, as will be described hereinafter, the wave shape burring 11 of the present invention is a means for providing a high screw fastening strength using a thin metal plate, and therefore, it is not limited to M3 but applicable to a meter fine pitch screw, small precision screw such as M1 screw to a large screw such as M4, M5 or the like.

In this embodiment, the fastening material 1 has a thickness 0.4 mm and is provided with a wave shape burring 11 for M3 size, and the fastening object material 2 (plate member) is provided with a screw hole 21 at a central portion in alignment with the wave shape burring 11. The screw 3 is a M3 RS tight (tradename) available from Nitto Seiko Kabushiki Kaisha, Japan, which is a hexagonal cross-recessed metric coarse tapping screw with a flange.

### (Fastening Portion Structure)

The wave shape burring 11 of the fastening material 1 will be described in detail.

As shown in part (a) of FIG. 2 and part (b) of FIG. 3, the back side of the fastening material 1 is provided with the wave shape burring 11 at a central portion of a fastening material flat surface portion 1a. The central portion of the wave shape burring 11 is a female screw hole 12. The wave shape burring 11 is generally cylindrical and is formed extending in a screw inserting direction to a height h from the fastening material flat surface portion 1a so as to enclose an outer circumference of an inner surface 11c of the female screw hole 12. The wave shape burring 11 comprises alternating trough portions lla and ridge portions 11b. Inner surface portions (that is, screw hole 11c) of bottom portions 11a′ of the trough portion 11a and crest portions 11b′ of the ridge portions 11b are engaged with a screw portion 32a of the screw 3. A distance to the crest portion 11b′ from the bottom portion 11a′ of the wave shape burring 11, more particularly thickness (h11) of the thickened screw hole in the burred portion (part (c) of FIG. 2) is 0.6-1.2 mm.

When fastened, a side of the screw head 31 which contacts the fastening object material 2 is provided with the dish-like screw flange portion 34, and the flange contact portion 2a (diametrically outermost portion) contacts the fastening object material 2. Thus, the fastening object material 2 is fastened to the fastening material flat surface portion 1a by the screw 3. Therefore, the contact portion is farther from the center than a normal screw case by the projection size of the screw flange portion 34, and therefore, the screw is less loosened, that is, the required loosening torque is higher.

A self-tapping formation portion of the screw shank 32 of the screw 3 (tapping screw) is threaded into the wave shape burring 11 portion by rotation, by which a female screw is formed in the inside circumference 11c of the wave shape burring 11, and the screw 3 is fastened to complete the fastening.

### (Structure of Fastening Portion of Fastening Material)

Referring to FIGS. 4-8, the fastening material 1 provided with the wave shape burring process will be described.

In FIGS. 4 and 6, the central portion screw hole 12 through the fastening material 1 from the front side Ba to the back side Bb is provided with the generally cylindrical wave shape burring 11, and therefore, the inside circumference 11c of the wave shape burring 11 has a prepared hole diameter d11 to be threaded into a female screw. The prepared hole diameter d11 is the same or substantially the same as the diameter of the screw threaded portion 32 of the screw 3. The wave shape burring 11 has radial ridge and trough portions at 10 equal intervals on a circumference thereon, wherein the ridges 11b and trough 11a appear alternately and continuously so as to provide, in effect, a large thickness h11.

In this embodiment, the plate thickness (t) of the fastening material 1 is 0.4 mm, and an inner diameter (d11) of the cylindrical portion is 2.459 mm which is a prepared hole diameter of a cut tapping or a rolling tap of metric coarse screw M3, or is 2.78 mm which is a prepared hole diameter of a self-tapping screw. The thickness (h11) of the thickened portion which is a one half of a difference between the inside diameters (d11) and the outside diameter of the wave shape burring 11 is 0.8 mm. It is the same as the plate thickness of 0.8 mm which is a normal process limit of burring for M3 screw. Therefore, if 0.8 mm thickness is accomplished by the thickening, a fastening force of torque 1.4N·m which is 70% of a screw rupture torque 2N·m can be provided.

Normally, the fastening force of the screw is approx. 70% of the rupture torque. In the case of the burring process for a metric coarse screw M3 and plate thickness 0.8 mm, a prepared hole diameter (d11) of the burring is 0.9 mm, and therefore, a burring height (h) is 1.4 mm including the plate thickness (t) because of constancy of volume (part (c) of FIG. 4). In the case of M3, a screw pitch is 0.5 mm, and therefore, a screw engagement amount of 2.5 leads can be assured.

In this embodiment, the plate thickness is 0.4 mm, and the prepared hole diameter (d11) of the burring 0.8 mm. Under these conditions, the wave shape burring 11 has been formed, by which the burring height (h) including the plate thickness was 1.6 mm. By doing so, the screw engagement amount of three leads could be provided. In addition, since an engaging lead of the screw is long, the torque in the fastened state can be dispersed, with the result of less damage to the burring and reduction of wearing in the case of repeated threading.

On the other hand, in the case of the burring for providing a proper fastening force of a M3 metric coarse tapping screw to a thin plate material of 0.4 mm thickness (t) of the fastening material 1 of metal material such as electrolytic zinc-coated steel plate or the like, a female screw hole 12 is formed in an inner surface 11c of a cylindrical of the wave shape burring 11 by tapping process or by tapping screw (screw 3).

This embodiment, the thickness (t) of the thin plate material (fastening material 1) is 0.4 mm, and a pitch of the metric coarse screw is 0.5 mm in the range of approx. 20%.

In the case of the thickness (t) of 0.3 mm, the applicability ranges from meter fine pitch screw M1 (screw pitch 0.2 mm) to M3 (screw pitch 0.35 mm), and metric coarse screw M1 (screw pitch 0.25 mm) to M3 (pitch 0.45 mm).

Similarly, in the case of metric coarse screw M4, the screw pitch is 0.7 mm, and therefore, the applicable plate thickness (t) ranges from M2 (screw pitch 0.4 mm) to M6 (screw pitch 1 mm). The present invention is applicable to a thickness smaller than the height of thread which is a pitch substantially equivalent to the different between the bottom and crest of the screw. Therefore, the applicability ranges between approx. ±40% of the pitch.

### (Manufacturing Method)

Reference FIGS. 6 and 8, a pressing working step for forming the wave shape burring 11 will be described in detail. As shown in FIGS. 6 and 8, in this embodiment, the fastening material 1 of the thin metal plate is a strip plate 1A, with which the burring 11 is formed on the fastening material flat surface portion 1a of the strip, using a progressive die of a sequential transfer pressing step.

Parts (a) and (b) of FIG. 6 and parts (a) the (b) and (c) of FIG. 7 illustrate burring process steps on the fastening material, and parts (c)-(e) of FIG. 6 are sectional views of examples of other burring configurations. Part (a) of FIG. 6 is a perspective view of the strip plate 1A as seen from the front side Ba, part (b) of FIG. 6 is a perspective view thereof as seen from the back side Bb. Part (a) of FIG. 7 is a side view, part (b) of FIG. 7 is a top plan view as seen from the front side Ba and part (c) of FIG. 7 is a sectional view.

Parts (a) and (b) of FIG. 6 and parts (a), (b) and (c) of FIG. 7, the pressing steps sequentially advances from the left to the right in the Figures.

The first step to the fastening material flat surface portion 1a is a deep drawing process, in which the deep drawing is effected into a semi-spherical shape to form a spherical portion which is convex (recessed) toward the back side Bb from the front side Ba of the fastening material flat surface portion 1a. The second step is piercing and radial bead forming process, in which a through-hole 12 which is going to be a screw hole is formed at the central portion of the drawn spherical portion 1b. In addition, drawn beads 11′a expanding radially and outwardly from the central portion are formed. The third step is a gathering and thickening step, in which the spherical drawn portion 1b of the back side Bb is gathered toward the center of the through-hole 12 as indicated by arrows C in part (b) of FIG. 6. More particularly, by the gathering, the radial beads 11′ formed by the second step are formed into a cylindrical shape 11′ while form a corrugation (thickening). In other words, the radial beads 11′ are folded into a cylindrical wave-like drawn portion 11′b. The fourth step is a flattening and tapping process (if necessary) step, in which the spherical portion 1b is flattened by pressing to be flush with the original fastening material flat surface portion 1a to accomplish a screw hole 12 provided with the wave shape burring 11.

In the first step, the fastening material 1 of the thin steel plate which is difficult to machine in the flat state is formed into a convex (recessed) toward the back side Bb, by which the fastening material 1 becomes easy for plastic deformation, and in addition, the beads 11′a can be formed.

In the third step, the spherical portion 1b is squeezingly gathered in the directions indicated by arrows C in part (b) of FIG. 6 toward the center of the through-hole 12, but actually, one stroke is not enough to reach an intended diameter, and therefore, a plurality of stroke are preferably used.

However, the increase of the strokes leads to increase of the number of metal molds, and therefore, the number of the strokes may be as small as possible as long as the height h11 of the waveform, that is the thickness of the wave shape burring can assure the necessary thickness.

The bead shape is not limited to those having channel like cross sections, but may be semicircle U-like configuration (part (d) of FIG. 6) or a V-like configuration (part (e) of the). Particularly, when the bending or drawing is different in the squeezing step, U-like cross section may be used, and then the stresses can be distributed, by which occurrence of a crack by bending can be avoided.

In the fourth step, if the inner diameter portions of the screw hole 12 are not even, the engagement amount of the screw substantially decreases with the result of reduction of the screw ridge rupture torque. Therefore, it is preferable to insert a shaft having a desired prepare hole diameter (d11) into the hole and the burring is pressed from the outside to the shaft. Or, in order to enhance the circularity or cylindricity of the inside circumference, the pressing is effected so as to form the burring with a slightly smaller diameter, and then a finishing step such as a broach machining, shaving or the like may be carried out.

It is determined depending on the actual use, as to whether the ridges are formed by a rolling tap or a tapping screw is used. Particularly, in the case of screw fastening of a printed board with which an electrical conductivity is required, a tapping using a rolling tap may be used, since then an assured torque management is possible so that the contact pressure for the electrical contact is assured.

Furthermore, after the press work, it is preferable that cleaning or the like is effected to remove chips and/or oil so as to avoid the cut chips resulting from the self-tapping of the tapping screw or the like falling to the electroconductive portion.

As described above, the cylindrical portion thickened by the wave-like (folded) shape burring can be provided.

### Embodiment 2

Reference FIGS. 8-14, an Embodiment 2 of the present invention will be described. In the above-described Embodiment 1, a wave shape burring 11 is formed on the circumference of the screw hole 12 at the back side Bb of the fastening material 1, but in this embodiment, substantially rectangular radial beads 4 are provided around the wave shape burring 11.

In this embodiment, in addition to the wave shape burring 11, the fastening material 1 of the thin plate material is provided with radially outwardly extending beads 4 which are disposed concentrically about the center of the female screw hole 12 by pressing.

Parts (a), (b) and (c), of FIG. 8 and parts (a) and (b) of FIG. 9 show a fastening material 1 of this embodiment. Around the screw hole 12 in the center portion of the back side Bb of the fastening material flat surface portion 1a, the wave shape burring 11 is provided similarly to Embodiment 1. The fastening material flat surface portion 1a is provided with radial drawn beads 4 at positions equally dividing the circumference, the beads 4 extending radially from a center O11 substantially concentrically about the center O11 of the wave shape burring 11. The beads 4 are recessed toward downstream with respect to the screw inserting direction. In this embodiment, it has a width 4w=0.5 mm, a deep 4h=0.4 mm, a length 4L=1.5-4 mm, and has rounded opposite ends. A distance from the screw hole 12 ΔL is 1 mm. By the provision of such beads 4, the bending strength of the fastening material flat surface portion 1a in the radial direction is enhanced. By such a reinforcement, the jack-up phenomenon-of the flat surface portion as in a conventional example of FIG. 1 can be reduced.

Above-described in the foregoing with Embodiment 1, the wave shaped cylindrical burring 11 provides the effective thickness (h11) of 0.8 mm for a plate thickness (t) of 0.4 mm, and therefore, the fastening strength is improved. Here, in order to meet more the improved strength, the strength of the fastening material flat surface portion 1a is enhanced by the provision of the radial drawn beads 4. It makes the plate thickness correspond to 0.8 mm, and therefore, the screw fastening reinforcement with good balance can be provided.

FIG. 10 illustrates a state in which the fastening material 1 of this embodiment and a fastening object material 2 are fastened by the screw 3, and part (a) of FIG. 10 is a perspective view as seen from the front side Ba, and part (b) is a perspective view as seen from the back side Bb. FIG. 11 illustrates a state of the fastening portion structure 90 in which the fastening material 1 of this embodiment and the fastening object material 2 are fastened by the screw 3, and part (a) of FIG. 11 is a side view, and part (b) is a top plan view of a front side, and part (c) is a partially sectional view.

As shown in part (c) of FIG. 11 particularly, an outer diameter D of a circumscribed circle of the radially extending rectangular beads 4 is larger than a diameter d of a contact portion 2a between the fastening object material 2 of the circular screw flange portion 34 extending outwardly from a screw neck 35 of the screw 3, and therefore, the fastening material 1 is reinforced against the deformation.

### (Manufacturing Method)

FIGS. 12 and 13, process steps for the wave shape burring 11 of this embodiment will be described. Also in this embodiment, similarly to a pressing working step shown in Embodiment 1, the pressing steps go sequentially from the left side to the right side in parts (a), (b) and (c) of FIG. 12 and parts (a) and (b) of FIG. 13.

The first step is a spherical drawing process, in which a spherical portion 1b convex to the back side Bb from the front side Ba of the fastening material flat surface portion 1a is formed. The second step is a piercing and radial bead forming step in which the beads 11′ for the wave shape burring 11 is formed. The third step is a drawing and gathering step (thickening) of forming a wave-like shaped burring. The fourth step is a flattening and tapping process (if necessary) step, and similarly to Embodiment 1, the wave shape burring 11 is formed.

In this embodiment, a fifth step is used for the bead forming process. More particularly, the radial drawn beads 4 concave (recessed) toward a downstream side in the screw inserting direction are provided around the wave shape burring 11.

In this embodiment, they equally divide the circumference into 10, but the number is not limiting, and may equally divide into 3, 4 or the like. The beads 4 are arranged circularly, but may be arranged triangularly, rectangularly, polygonaly or into another shape having an arc. The radial drawn beads 4 are effective to enhance the strength in the fastening portion structure 90 of the fastening material 1, and the jack-up deformation upon screw fastening is reduced.

### Embodiment 3

Referring to FIGS. 14-17, Embodiment 3 of the present invention will be described.

This embodiment is different from the foregoing embodiments in that the above-described additional radial drawn beads 41 of Embodiment 2 is continuous and integral with the projections of the wave shape burring 11.

FIGS. 14-17 illustrate this embodiment. Parts (a), (b) and (c) of FIG. 14 and parts (a) and (b) of FIG. 15 illustrate a fastening material 1 of this embodiment. Part (a) of FIG. 14 is a side view, part (b) of FIG. 14 is a top plan view as seen from a front side Ba, and part (c) is a sectional view. Part (a) of FIG. 15 is a perspective view as seen from a front side Ba, and part (b) is a perspective view as seen from the back side Bb. Parts (a), (b) and (c) of FIG. 16 and parts (a) and (b) of FIG. 17 illustrate pressing working steps for the burring 11 of the fastening material 1 of this embodiment. Similarly to Embodiments 1 and 2, in parts (a), (b) and (c) of FIG. 16 and parts (a) and (b) of FIG. 17, the pressing steps go sequentially from the left side to the right side. Part (a) of FIG. 16 is a side view, part (b) of FIG. 16 is a top plan view as seen from a front side Ba, and part (c) is a sectional view. Part (a) of FIG. 17 is a perspective view as seen from a front side Ba, and part (b) is a perspective view as seen from the back side Bb.

As shown in FIGS. 14 and 15, in this embodiment, thickening wave-like shape burring 11 is formed in the fastening material 1 of thin metal plate. Around the wave shape burring 11, radial beads namely radial drawn beads 41 are formed as in Embodiment 2.

As shown in FIGS. 14 and 15, the screw hole burred portion of the fastening material 1 includes wave form ridges 11b and troughs 11a appearing alternately at equally divided circumferential 10 positions around the wave shape burring 11 (thickening). The wave shape burring can be formed similarly to Embodiment 2. The beads 11′ shown in FIGS. 16 and 17 are gathered, and the beads 11′ are elongated so that the wave shape burring 11 remains outside, by which the radial drawn beads 41 are formed. Thus, the beads 11′ and beads 41 are formed by the same pressing step. By the provision of the continuous bead shapes, the strength of the base portion of burring is further enhanced. The deformation adjacent the base portion of burring which is characteristics of the jack-up deformation by the screw fastening force. According to this embodiment, the base portion of burring at the fastening material flat surface portion 1a are redundantly reinforced by the circumferential direction reinforcement and the radiation bead reinforcement, and therefore, the thin plate portion is not easily deformed even by a strong torque fastening force. The pressing steps shown in FIG. 16 and FIG. 17 are similar to Embodiment 2, but the radial beads 41 extend from the wave shape burring 11. In other words, the radial beads 41 are continuous with the wave shape burring 11, and the ridges and troughs are continuous therebetween.

The first step is a deep drawing step for the fastening material flat surface portion 1a, in which a spherical portion 1b convex from the front side Ba to the back side Bb of the fastening material flat surface portion 1a is formed. The second step is piercing and radial bead forming process, in which a through-hole 12 which is going to be a screw hole is formed at the central portion of the drawn spherical portion 1b. In addition, beads 11′a extending radially from the center are formed. The drawn beads 11′a formed at this time are longer than those in Embodiments 1 and 2. The third step is a gathering and thickening step, in which the spherical portion is gathered toward the center into a cylindrical shape 11′b, while forming the radial beads 11′a. The beads 11′a do not entirely form into the cylindrical shape 11′b but partly remains as parts of the bead 11′a. The fourth step is a flattening and tapping process step, in which the spherical portion 1b is flattened by pressing to be flush with the original fastening material flat surface portion 1a to provide the radial beads 41 continuous with the wave shape burring 11.

### Embodiment 4

Referring to FIGS. 18-21, Embodiment 4 of the present invention will be described.

This embodiment is different from Embodiments 2 and 3 in that the radial drawn beads 4 concentrically with the wave shape burring 11 have configurations expanding toward outside in the fastening material flat surface portion 1a of the fastening material 1 (substantially sector-shaped).

Parts (a), (b) and (c) of FIG. 18 and parts (a) and (b) of FIG. 19 illustrate a fastening portion structure 90 in which a fastening object material 2 of plate member is fastened by a screw 3 using a fastening material 1 of this embodiment. Part (a) of FIG. 19 is a perspective view as seen from a front side Ba, and part (b) is a perspective view as seen from the back side Bb. Parts (a), (b) and (c) of FIG. 20 and parts (a) and (b) of FIG. 21 illustrate the fastening material 1 of this embodiment, part (a) of FIG. 20 is a side view, part (b) of FIG. 20 is a top plan view as seen from a front side Ba and part (c) is a side view. Part (a) of FIG. 21 is a perspective view as seen from the front side Ba, part (b) is a perspective view as seen from the back side Bb in the fastened state.

A flange contact portion 2a where the strength decreases by the screw fastening as the distance from the wave shape burring 11 increases, is reinforced, so that the deformation of the thin plate fastening material 1 by the screw fastening force is reduced. Simultaneously, upon the spherical drawing of the first step in the pressing step, the sector-shape portion can push the material so that it gathers in the central portion, and therefore, the thinning of the central portion of the fastening material 1 can be suppressed.

According to the present invention, a thin metal plate material is subjected to the burring process so that the screw fastening can be effected with a high fastening torque.

While the present invention has been described with reference to exemplary embodiments, it is to be understood that the invention is not limited to the disclosed exemplary embodiments.The scope of the following claims is to be accorded the broadest interpretation so as to encompass all such modifications and equivalent structures and functions.

This application claims priority from Japanese Patent Application No. 052547/2013 filed Mar. 14, 2013 which is hereby incorporated by reference.

What is claimed is:

1. A fastening material for fastening a fastening object material between itself and a screw, said fastening material comprising:
a burred portion forming a screw hole and projecting in a substantially cylindrical shape in a screw inserting direction,
wherein said burred portion has a wave-like shape portion waving in a circumferential direction of the cylindrical shape.

2. A fastening material according to claim 1, wherein said fastening material is provided with beads radially outside of an outer diameter of said burred portion, said beads extending outwardly away from a center of the screw hole, and wherein said beads extend outwardly beyond a diameter of a screw head of the screw and is recessed in a screw inserting direction.

3. A fastening material according to claim 2, wherein said beads are provided corresponding to a waveform of said wave-like shape portion.

4. A fastening material according to claim 2, wherein said beads are substantially rectangular extending radially outwardly from an outer periphery of said burred portion.

5. A fastening material according to claim 2, wherein said beads each expand as distances from said burred portion increase.

6. A fastening material according to claim 2, wherein said beads are arranged circularly around said burred portion.

7. A fastening material according to claim 1, wherein said fastening material is made of a thin metal plate.
